(19) United States
(12) Patent Application Publication
(10) Pub. No.: US 2004/0143398 A1
(43) Pub. Date: Jul. 22, 2004

(54) Method and system for monitoring vibration and/or mechanical waves in mechanical systems

(76) Inventor: Mitchell C. Nelson, Rehoboth, DE (US)

Correspondence Address: Mitchell P. Novick, Esq., Law Offices Of Mitchell P. Novick, 66 Park Street, Montclair, NJ, 07042, US

(21) Appl. No.: 10/752,201

(22) Filed: Jan. 5, 2004

Related U.S. Application Data
(60) Provisional application No. 60/437,963, filed on Jan. 3, 2003.
(60) Provisional application No. 60/437,964, filed on Jan. 3, 2003.
(60) Provisional application No. 60/437,967, filed on Jan. 3, 2003.
(60) Provisional application No. 60/437,968, filed on Jan. 3, 2003.

(51) Int. Cl. G01V 1/00

(52) U.S. Cl. 702/14

(57) ABSTRACT

Methods and devices are disclosed for measuring vibration and/or mechanical waves, such as acoustic signals, in mechanical systems, for detecting and characterizing mechanical events in mechanical systems, for enhancing the performance of pattern recognition including without limitation artificial intelligence methods, and for monitoring and assessing the condition of mechanical systems such as motors, structures, and structural elements. Applications include, without limitation, jet engine monitoring, failure detection and prediction in composite materials, and physical security for moveable assets such as aircraft.

### CROSS-REFERENCE TO RELATED APPLICATIONS

This application claims the benefit of the following four (4) United States Provisional Patent Applications:

(1) Serial No. 60/437,963, filed 3 Jan. 2003;

(2) Serial No. 60/437,964, filed 3 Jan. 2003;

(3) Serial No. 60/437,967, filed 3 Jan. 2003; and

(4) Serial No. 60/437,968, filed 3 Jan. 2003,

the contents of all of which are hereby incorporated by reference.

### FIELD OF THE INVENTION

The present invention relates to methods and means for acquiring vibration and mechanical wave data, such as acoustic signals, in mechanical systems (machines and structures), for detecting and characterizing transient and repetitive phenomena in mechanical systems, and for monitoring and diagnosing faults in mechanical systems. The invention comprises methods and devices for acquiring and processing vibration and mechanical data in a way that avoids the contributions of reflections, and, thereby, (I) obtaining better performance from artificial intelligence techniques, such as neural networks, and pattern recognition techniques in general, (ii) obtaining position-orientation and type classification of mechanical events, (iii) obtaining more reliable mechanical monitoring and diagnostics, (iv) reducing the amount of data needed to train AI systems in mechanical monitoring applications, and (v) obtaining more accurate vibration or acoustic spectra in mechanical systems. The invention comprises new windowing techniques, techniques for associating individual events with specific features of vibration or acoustic spectra, and a novel use of echo cancellation in vibration and acoustic monitoring.

### BACKGROUND OF THE INVENTION

It is imperative to have accurate and reliable failure detection and prediction in every industry in which a safety or economic issue depends on the reliability of a mechanical system. A mechanical system, by way of example, may be a motor or engine, a machine, or a structure or structural element. Specific examples are airplane engines, paint sprayers in automobile assembly lines, or aircraft wings and tail structures. In each of these examples, there is a large safety or cost issue, and in each case there is a history of efforts to find reliable and cost effective technologies to monitor the mechanical system.

The popular technologies for machine and structure monitoring include devices that (a) monitor vibration, sound, temperature, pressure, and/or efficiency or output, (b) classify or recognize signals or behaviors to detect and characterize events, and/or determine the system's condition, and (c) store or display the data and/or conclusions, or communicate the data and/or conclusions to another system.

Vibration and acoustic monitoring, is, in many situations, a preferred technology for machine and structural monitoring because of its specificity and its sensitivity to early stage and transient failure conditions. Temperature or output measurements may indicate that a system is failing, but the information is less specific and deviations are often only noticeable as the failure nears its end stage. Vibration and acoustic waves are specific to nearly any mechanical process or event and they may be used to detect and identify early stage and transient failures.

Artificial intelligence (“AI”), and related techniques, has potential to increase the capabilities, reliability and financial benefit of machine and structure monitoring. Prior art systems typically are based on threshold techniques or pre-defined rules, and, consequently, offer narrow capabilities. AI offers the potential to mimic or exceed human capabilities for behavior or pattern recognition and fault detection.

AI has the potential to be a powerful adjunct to vibration and acoustic monitoring, in particular. Neural networks, one of the simplest examples of AI, have been shown to be universal approximators and they are well known for their ability to generalize. These properties, and the fact that humans may be trained to use sound and vibration to monitor and diagnose mechanical systems, suggest that AI systems should also be able to use sound and vibration to detect and classify faults in mechanical systems.

In practice, however, the combination of AI with vibration and acoustic monitoring in mechanical systems has been unreliable and expensive. In the prior art, AI typically produces high rates of false reports and requires large quantities of training data gathered from real systems and usually at great cost. These problems have remained unsolved in the prior art despite many significant advances in technology and mathematics of AI and related pattern recognition techniques.

In short, reliable and economical use of pattern recognition techniques in general, and AI in particular, in mechanical systems, may provide important safety and economic benefits in a wide range of industries and applications. AI has not worked well in vibration and acoustic monitoring. However, AI has the ability to solve suitably presented deterministic problems.

### BRIEF SUMMARY OF THE INVENTION

The main shortcoming in applying AI to vibration and/or acoustic monitoring is the inadequacies in acquiring the necessary vibration and/or acoustic data from the systems. Improving the way that the data is acquired greatly improves the utility and reliability of AI in vibration and acoustic monitoring.

According to this invention, vibration and/or acoustic data are acquired at one or several locations and/or orientations in a mechanical system, in a manner that excludes multiple copies of waveforms due to reflections from edges, boundaries, and couplings in the mechanical system. The resulting data is processed by pattern recognition techniques, including AI methods such as neural networks or Kohonen networks, to reliably detect and characterize physical events and vibrations, to obtain parameters such as location or orientation, to recognize the type of event, and/or, to reliably and economically monitor and diagnose machines and structures. The membership of the event in a specific vibration is obtained by combining the technique with a spectral frequency estimation method.

### BRIEF DESCRIPTION OF THE SEVERAL VIEWS OF THE DRAWINGS

The following drawings provide details of the present invention.

FIG. 1. is a schematic diagram of a version of the instant invention used for acquiring and processing whole system vibration-acoustic monitoring (“WSVAM”) data.

FIG. 2 is a schematic diagram of data flow in the version shown in FIG. 1.

FIG. 3a is a schematic diagram of signal detection and windowing in the instant invention.

FIG. 3b is a schematic diagram of signal detection and windowing with inline frequency estimation in the instant invention.

FIG. 4 is a schematic diagram of data processing in a version of the instant invention used for machine/structure monitoring.

FIG. 5 is a schematic diagram of data processing in a version of the instant invention used for jet engines/rotating machinery analysis.

### DETAILED DESCRIPTION OF THE INVENTION

A. Introduction

This description of the invention discusses mainly a specific type of mechanical wave, the acoustic wave. However, it should be obvious to anyone skilled in the relevant art that other types of mechanical waves may be analyzed and utilized similarly to the acoustic wave.

The invention comprises a method for acquiring and processing data from mechanical waves in a mechanical system by using one or a plurality of sensors and sampling algorithms as described below. For purposes of simplicity, this method is referred to as “whole system vibration-acoustic monitoring” (“WSVAM”).

Mechanical waves contain a wealth of information about the mechanical events that they originate from and about the condition of the mechanical system in which they propagate. Because anything that happens in a real world mechanical system produces mechanical waves, vibration and acoustic monitoring of these waves may provide highly reliable and detailed diagnostics for the mechanical systems.

Mechanical wave propagation, in mechanical systems of finite size and with many components, is an extremely complicated phenomenon. Wave velocities vary with mode and frequency. Waves may be reflected by edges or boundaries, or by defects. Propagation modes are determined, in a detailed way, by the shape, material, and construction of the mechanical system. Nonetheless, the resulting waves have a deterministic relationship with the source event and the condition of the mechanical system. Therefore, the interpretation of vibration and acoustic data for machine and structure monitoring and diagnostics, should be within the class of problems that may be solved by a variety of pattern recognition methods and by neural networks in particular.

According to this invention, the interpretation of vibration or acoustic data from a mechanical system is optimized by acquiring and processing vibration or acoustic signals in a manner that satisfies the following three criteria—or in worst case at least the third of the following criteria (in addition to the usual criteria for data acquisition):

(I) A plurality of sensors should be deployed to monitor the system at more than one location including locations near the perimeter of the system, and/or along more than one axis, according to the geometry of the system.

(ii) Data should be acquired from the plurality of sensors in a manner that preserves the timing relationships among the data from the sensors (for example, simultaneous acquisition).

(iii) The sampling algorithm should provide a useful number of samples from each sensor at a rate (or timed sequence) that adequately samples the signals or features of interest, and the data should be windowed in time to exclude significant reflections, or equivalently, subsequent processing should not effectively average the data over an interval in time that is equal to or larger than the interval between significant reflections.

An alternative to the second part of the third criterion is to remove reflections using an echo cancellation technique. However, reflections may partially overlap the original event, depending on the details of the system and the event, and so this poses a difficult problem. Windowing provides a more rigorously deterministic solution. The first and second criteria provide the possibility that the data contains useful phase information. The first part of the third criterion provides that the data adequately sample any single feature of interest, although it may be one instance of a repetitive event making up a vibration. The second part of the third criterion prevents the data from being corrupted by combining multiple (reflected) versions of the signal in a way that would obscure any deterministic relationship between phase and/or amplitude and the phenomena of interest.

For an example of the workings of this invention, consider a bar with a length of 1 meter and a sensor located near each end. A ball bearing repetitively impacts on the bar near one end, at a rate of 40 times per second (2,400 cycles per minute—“CPM”). The resulting mechanical wave is picked up at the nearby sensor each time the bearing hits and then again after the wave propagates to the other end of the bar and back to the sensor. If the wave velocity is 2.5 km/s, the reflections appear at about 400 μsec (microsecond) intervals (2.5 kHz).

In this example, an FFT of 8 or more samples and a sampling rate of 20 KHz or less, will effectively average the direct signal with one or more of its reflections. If the FFT is done on 1024 samples, an interval large enough to include 128 reflections, the result is a data set whose phases, amplitudes, and line shapes have little or no deterministic mapping back to the location, orientation, or other characteristics of the mechanical event that gave rise to the signal. Similar results may be obtained without the FFT, by using low sampling rates.

Pattern recognition techniques, including neural networks, perform poorly when asked to interpret frequency or time domain data produced by methods that use large time domain data windows or low sampling rates. The data does not have enough information that is deterministically related to the intended output.

Nevertheless, by applying the above criteria to timing and sampling, optimum performance from pattern recognition techniques, including neural networks and independent component analysis, may be obtained with data windows and sampling rates that meet the above criterion, or by otherwise removing the contributions of reflections (for example by echo cancellation) where feasible or by employing mechanical measures that appreciably alter the wave properties of the mechanical system being monitored.

The best performance, when location or orientation is important, also depends on obtaining data simultaneously at multiple locations and/or along multiple directions. Nonetheless useful information, though less of it, may be obtained from a single sensor provided the system at least meets the third criterion. The third criterion applied to a single sensor, gives high quality transient measurements and it may be used to give a substantially more reliable power spectra than is obtained in the presence of reflections.

B. Device for Acquiring and Processing WSVAM Data, Classifying Mechanical Events, and Machine and Structure Monitoring

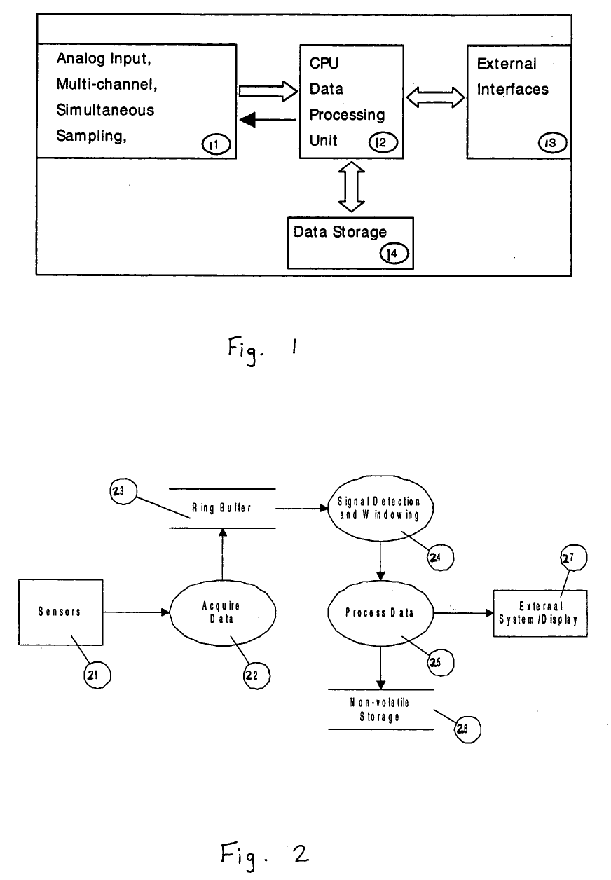

One embodiment of this invention (FIG. 1) shows schematically a device for acquiring and processing WSVAM data. The device comprises a high speed simultaneous sampling analog input 11, a central processing unit (with memory) 12, non-volatile data storage 14, and external interfaces 13 that drive displays and/or communicate with other devices or systems. The central processing unit comprises a computer processor, memory and interfaces to the other components. The processor, memory and interfaces have sufficient capacity and bandwidth to retrieve data from the analog input, process the data, relay the data to the non-volatile storage device and/or the external interfaces, and respond to commands.

FIG. 2 depicts a data flow diagram for the operation of this embodiment. The processes are implemented in software running in the central processing unit. The software may be assisted by special purpose devices optionally included in the central processing unit.

Raw data, from one or a plurality of sensors 21, is acquired by the data acquisition process 22 and is added to a ring buffer 23. The signal detection and windowing process 24 (described below) scans the ring buffer, and, extracts and passes data to the data processing process 25. The data processing process 25 (described below) processes the data to implement the pattern recognition functionality specific to the application. Raw data, intermediate data, and/or the outputs of the data processing process are saved to non-volatile storage 26, and/or transferred to an external device 27 such as a display panel or remote computing system.

C. Signal Detection and Windowing

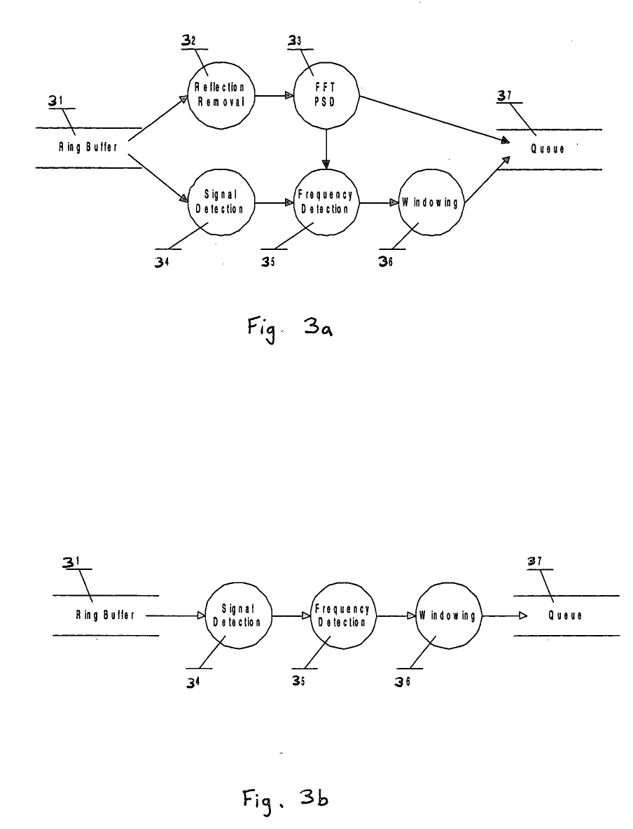

The signal detection and windowing process is shown diagrammatically in FIG. 3. It has two sub-systems, the primary sub-system being composed of a signal detection module 34, a frequency detection module 35, and a windowing module 36, and the second, a reflection remove module 32 and an FFT/PSD module 33. The data from both or either sub-system may be passed to the input queue 37 of the data processing function and any of the modules may be bypassed. The signal detection module 34 offers two options:

(I) Signal detection by selectable threshold in amplitude or slope.

(ii) Signal detection using a likelihood-ratio detector implemented in a neural network.

The frequency detection module 35 determines whether the detected signal is part of a repetitive signal (a vibration or acoustic phenomena other than a reflection), and passes the information along with the data to the windowing function. The frequency detection module operates in either of two modes:

(I) Frequency detection based on FFT/PSD and likelihood estimator.

(ii) Frequency detection using AI based frequency estimator with echo discrimination.

A likelihood that the detected signal corresponds to a signal at frequency f is based on the presence of a signal at that frequency in the spectra generated by the FFT/PSD function, and on the presence of signals at intervals of Dt=1/f on either side of the detected signal. The most likely frequency or the entire “likelihood spectrum” is passed with the data into the next function.

Optionally, frequency estimation is done using a neural network based frequency estimator. The frequency estimator scans the raw data and attempts to recognize repeat intervals referenced to the detected signal while discriminating against reflections. Its function is facilitated by the existence of a maximum time interval for a first reflection (in accord with the longest dimension of the object being monitored). In this mode of operation, the reflection removal and FFT/PSD modules may be disabled (see FIG. 3b), unless directly calculated FFT/PSD data are needed in the application.

The windowing function 36 offers two options:

(I) Selectable fixed window offset relative to the beginning of the detected signal and selectable fixed window width.

(ii) Adaptive windowing controlled by a neural network within selectable ranges.

Frequency spectra are generated and maintained by the FFT/PSD module 33 (when enabled). The reflection removal module 32 scans the ring buffer 31 and attempts to remove reflections while passing one frame of data into the FFT/PSD module 33. The FFT is optionally converted to a PSD and the PSD may be signal averaged. The reliability of the phase and amplitude in the FFT/PSD depends on the extent to which the reflection removal module is able to remove reflections from the data. The reflection removal algorithm uses an adaptive echo cancellation technique.

The FFT/PSD module maintains a copy of the most recent completed spectrum, or signal averaged PSD, that may be accessed by the frequency detection module 35.

D. Data Processing for Machine and Structure Monitoring

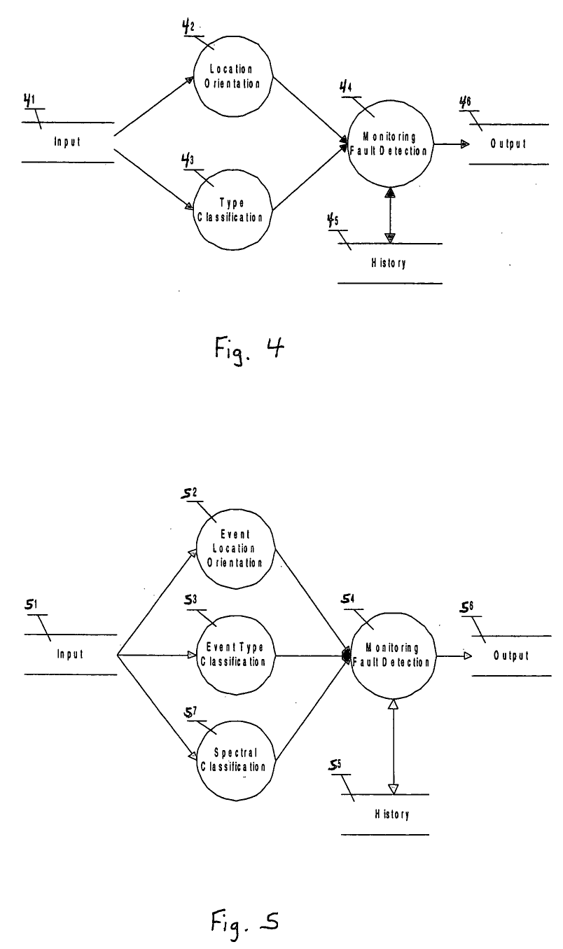

FIG. 4 shows a data flow diagram for the data processing module for machine and structure monitoring. Data is added to the input queue 41 by the signal detection and windowing process. The location and orientation module 42 classifies the input data to obtain location and orientation information; the type classification module 43 classifies the input data to obtain the type of event. The monitoring and fault detection module 44 classifies the location-orientation and type information to report events or to monitor a system to detect and report faults.

E. Position and Orientation of Sources

Position and orientation information is obtained using a neural network. Training is accomplished based on sample mechanical inputs delivered over the spatial domain of the mechanical system to be monitored. Training and testing should assure that the result is a robust classifier that is not sensitive to the type, hardness or strength of the input.

F. Type Classification

Type classification, to identify the type of event that produced a signal, is implemented using a neural network trained to recognize different types of events from single waveforms, and, frequency-estimation or frequency-likelihood information if enabled. Example types could be the type or severity of a shock or contact, for composites, a layer separation event, or for machinery, failed gear teeth, bearings, or bushings.

G. Machine and Structure Monitoring

Machine or structure monitoring is implemented with an additional neural network that assesses mechanical condition based on position and orientation, event type, frequency, and power or energy deposition using current inputs and history. Anomaly detection is provided within the neural network. A second embodiment adds a Kohonen network for anomaly detection. A third embodiment assesses machine or structure condition using fuzzy rules.

H. Reduction in Cost of Training Data

Separating out the position, orientation, part of the problem, provides a substantial reduction in the amount of data needed to train the neural networks. The number of types of failures, bearings, gears, bushings, etc., plus the number of locations and orientations, is a much smaller number than the full combinatorial product of these two sets.

I. Structure Monitoring with Position Resolution

Structure monitoring is provided by monitoring, processing and classifying spontaneous acoustic emissions produced under load. In a second embodiment, a wave excitation source is used to provide impulse inputs to probe the system.

J. Performance of Pattern Recognition

The use of neural networks and Kohonen networks constitute two examples of pattern recognitions techniques. There is a large field of such well-known techniques that perform well with WSVAM. The elimination of reflections from the measurements of mechanical waves provides data that work well with pattern recognition techniques in general, compared to traditional methods such as FFT.

K. Jet Engine and Rotating Machinery

Rotating machinery, including without limitation jet engines, is monitored using a combination of highly directional, low frequency, accelerometers, and high bandwidth sensors. The accelerometers are located at either end of the engine or machine, with orientations to capture three axes of acceleration at each end. These will primarily capture gyrations and oscillations. The high bandwidth sensors are distributed around the engine to locate and classify internal vibrations and transients. High bandwidth sensors with good directional specificity may be used to combine both functions.

The signal detection and windowing process is configured to generate the usual event based data, with FFT production enabled, and both the event data and the complex FFT data are passed to the data processing process.

Data processing for jet engines and rotating machinery is shown diagrammatically in FIG. 5. The data processing module takes data from its input queue 51. Event data is processed as before in the location orientation module 52 and the type classification module 53. Complex FFT data is passed to the spectral classification module 57, which reports gyrations, oscillations, overall rotational speed, and overall acceleration. The monitoring and fault detection module 54, considers inputs from all three modules.

L. Physical Security for Moveable Assets

Vibration and acoustic monitoring for physical security is implemented following the data process model depicted in FIG. 5. High sensitivity, high bandwidth sensors are distributed around the object. Piezoelectric film sensors work well in this application: The location orientation module 52 is trained to report the physical location of mechanical contacts with the object. The type classification module 53 is trained to report characteristics of the contact, energy, hardness, etc. The spectral classifier 57 may recognize mechanical tampering and mundane environmental type disturbances. The monitoring module 54 considers inputs from all three modules and reports the security relevance of mechanical events.

M. Frequency Domain Operation

The device may optionally produce and process frequency domain data alone, that is, in place of the time domain data and combinations of time and frequency domain data described above.

Complex FFT and PSD spectra that are substantially better than what is usually produced in standard vibration and acoustic monitoring systems, may be obtained from the FFT/PSD module 33 with reflection removal 32 enabled.

Alternatively, a good PSD spectrum may be constructed as a histogram of signals obtained from the windowing function 36 apportioned per the frequency-estimation or frequency-likelihood information.

Machine and structure monitoring based on frequency domain vibration and acoustic monitoring may yield higher quality, more reliable, results from FFT or PSD data that is not been corrupted by reflections compared to that which is obtained from vibration or acoustic spectra that have been obtained in the usual way.

The data processing function (not shown) for working in the frequency domain is an optional embodiment. The FFT or PSD may be processed in one or several steps depending on the application.

Although this invention has been described with a certain degree of particularity, it is to be understood that the present disclosure has been made only by way of illustration, and that numerous changes in the details and arrangement of parts may be resorted to without departing from the spirit and scope of the invention.

I claim:

1. A method for collecting data regarding a mechanical wave in a mechanical system comprising the step of obtaining data from a sensor at a location of the system, such that an effect of a reflection of the wave is minimized.

2. A system for collecting data regarding a mechanical wave in a mechanical system comprising a sensor located at a location of the system and data collection means for collecting data from the sensor such that an effect of a reflection of the wave is minimized.
